(19) United States
(12) Patent Application Publication
(10) Pub. No.: US 2016/0016133 A1
(43) Pub. Date: Jan. 21, 2016

(54) SYSTEM AND METHOD FOR BLENDING CONTAINMENT ASSEMBLY

(71) Applicant: Manitowoc Foodservice Companies, LLC, Manitowoc, WI (US)

(72) Inventors: Michael Merritt, Louisville, KY (US); James W. Brown, Crestwood, KY (US); Gorm Bressner, Providence, RI (US); Aaron Spinkle, Charlestown, IN (US)

(21) Appl. No.: 14/799,914

(22) Filed: Jul. 15, 2015

Related U.S. Application Data
(60) Provisional application No. 62/024,720, filed on Jul. 15, 2014.

(51) Int. Cl. B01F 7/16; B01F 15/00

(52) U.S. Cl. CPC B01F 7/1695; B01F 15/00779; B01F 15/00538

(57) ABSTRACT

A blending containment assembly includes a cover having a first aperture and a cup seal connected to the cover. The cup seal is a flexible material having a second aperture. The cover and the cup seal are configured to receive a spindle of a blending assembly in the first aperture and the second aperture. The cover and the cup seal are movable to engage a cup to create a seal between an inside of the cup and an outside of the cup.

This application claims the benefit of U.S. Provisional Application No. 62/024,720, filed Jul. 15, 2014. The contents of U.S. Provisional Application No. 62/024,720, filed Jul. 15, 2014, are hereby incorporated by reference herein in their entirety.

### BACKGROUND OF THE DISCLOSURE

1. Field of the Disclosure

The present disclosure relates generally to a method and apparatus for a blending containment assembly. More particularly, the present disclosure relates to a blending containment assembly that seals a cup during a blending cycle.

2. Description of Related Art

Beverages, for example, a smoothie drink, can require blending of beverage ingredients including ice and flavor ingredients during a blend cycle. Flavor ingredients include liquid flavor ingredients, for example, fruit juice and chocolate syrup, and solid ingredients, for example, fruit and solid chocolate pieces. Many challenges are encountered during a blend cycle when blending in a cup that is disposable, which is then served to the consumer in the same cup in which blending cycle took place. Cups that are disposable may be deformed during the blending cycle, for example, due to the forces applied to the cup to blend the beverage ingredients as well as forces applied to the cup to prevent the cup from rotating during the blend cycle.

Further, during the blend cycle, an un-sealed cup will allow the contents of the cup, namely, the beverage ingredients, to spill over the edges or cup lip, causing the cup to be messy or sticky. To prevent such spillage, the cup may be filled to a lower level with beverage ingredients prior to the blend cycle. However, the customer will receive a cup that is less than full, which can cause the customer to be dissatisfied with the amount of beverage received in the cup. If spillage does occur during the blend cycle, the cup needs to be wiped clean before handing the cup to the customer. Wiping causes a potential for use of re-usable towels that can collect bacteria over time and deposit the bacteria undesirably back onto the cups given to customers. Spillage over the outside of the cup increases drink preparation time by requiring cleaning of the outside of the cup prior to giving the beverage to the customer. Systems which rely on the operator to manually pour the completed beverage into a cup, runs the risk of spillage onto the outside of the cup as well. This necessitates wiping the outside of the cup which increases the overall drink preparation time.

Accordingly, it has been determined by the present disclosure, there is a need for a blending containment assembly that seals a cup during a blending cycle.

### SUMMARY

A blending containment assembly is provided that includes a cover having a first aperture and a cup seal connected to the cover. The cup seal is a flexible material having a second aperture. The cover and the cup seal are configured to receive a spindle of a blending assembly in the first aperture and the second aperture. The cover and the cup seal are movable to engage a cup to create a seal between an inside of the cup and an outside of the cup.

The above-described and other advantages and features of the present disclosure will be appreciated and understood by those skilled in the art from the following detailed description, drawings, and appended claims.

### BRIEF DESCRIPTION OF THE DRAWINGS

FIG. 1 is a partial cross-sectional side view of a blender assembly having a blending containment assembly according to the present disclosure.

FIG. 2 is an enlarged top, side perspective view of a portion of the blender assembly having the blending containment assembly of FIG. 1.

FIG. 3a is a side view of a free length of a spring.

FIG. 3b is a side cross-sectional view of the blender assembly having the blending containment assembly of FIG. 1 in a home position.

FIG. 4a is a side view of the free length of the spring.

FIG. 4b is a side cross-sectional view of the blender assembly having the blending containment assembly of FIG. 1 in an engaged position.

FIG. 5a is a side view of the free length of the spring.

FIG. 5b is a side cross-sectional view of the blender assembly having the blending containment assembly of FIG. 1 in a lowered position.

FIG. 6 is an enlarged side cross-sectional view of a portion of the blender assembly having the blending containment assembly of FIG. 1 with the spindle in the engaged position.

FIG. 7 is an enlarged side cross-sectional view of a portion of the blender assembly having the blending containment assembly of FIG. 1 showing a direction of travel of the spindle and a direction of travel of an object contacting a cup seal of the blending containment assembly.

FIG. 8 is an enlarged side cross-sectional view of a portion of the cup seal showing a direction of travel of liquid contacting the cup seal when the cup seal is not contacting a cup.

FIG. 9 is an enlarged side cross-sectional view of a portion of the blender assembly having the blending containment assembly of FIG. 1 showing a direction of travel of liquid contacting the cup seal when the cup seal is contacting the cup.

FIG. 10 is an enlarged side cross-sectional view of a portion of the blender assembly having the blending containment assembly of FIG. 1 with the spindle in the lowered position.

FIG. 11 is an enlarged side cross-sectional view of a portion of the blender assembly having the blending containment assembly of FIG. 1 showing a flow of air venting past the cup seal and through the cup cover.

FIG. 12 is an enlarged side cross-sectional view of a portion of the blender assembly having the blending containment assembly of FIG. 1 showing a position of the spindle when the cup seal initially contacts the cup.

FIG. 13 is an enlarged side cross-sectional view of a portion of the blender assembly having the blending containment assembly of FIG. 1 showing a direction of flow of ingredients in the cup as the spindle is moved into the cup.

FIG. 14 is top side perspective view of a cover holding the cup seal of the blending containment assembly of FIG. 1.

FIG. 15 is top side, exploded perspective view of the cover and the cup seal of the blending containment assembly of FIG. 1.

FIG. 16 is graph showing spring forces for various combinations of springs at different points in a blend cycle.

FIG. 17 is graph showing cups that leaked in a blender assembly not having the blending containment assembly of FIG. 1.

FIG. 18 is graph showing cups that leaked in the blender assembly having the blending containment assembly of FIG. 1.

FIG. 19 is a partial side cross-sectional view of a blender assembly having a second embodiment of a blending containment assembly according to the present disclosure.

FIG. 20 is a partial side cross-sectional view of a blender assembly having a third embodiment of a blending containment assembly according to the present disclosure.

FIGS. 21-22 are partial side cross-sectional views of a blender assembly having a fourth embodiment of a blending containment assembly according to the present disclosure.

FIGS. 23-24 are partial side cross-sectional views of a blender assembly having a fifth embodiment of a blending containment assembly according to the present disclosure.

FIG. 25 is a partial side cross-sectional view of a blender assembly having a sixth embodiment of a blending containment assembly according to the present disclosure.

FIG. 26 is a partial side cross-sectional view of a blender assembly having a seventh embodiment of a blending containment assembly according to the present disclosure.

FIG. 27 is a partial bottom side perspective view of a blender assembly having the seventh embodiment of the blending containment assembly.

FIG. 28 is a partial side cross-sectional view of an eighth embodiment of the blending containment assembly according to the present disclosure.

FIG. 29 is an enlarged side cross-sectional view of a portion of the blender assembly having the blending containment assembly of FIG. 1 with the spindle in the engaged position having a chamber seal and a cover seal.

FIG. 30 is an enlarged side cross-sectional view of a portion of a blend chamber of the blender assembly having the blending containment assembly of FIG. 1 having a centering ring that is attached to a grate in a bottom of the blend chamber.

### DETAILED DESCRIPTION OF THE DISCLOSURE

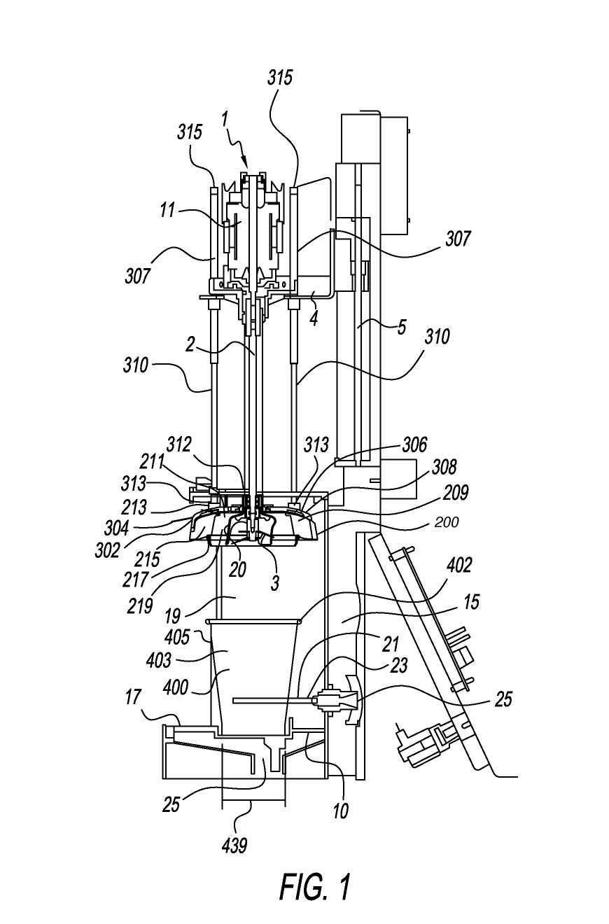

Referring to the drawings and in particular to FIG. 1, an exemplary embodiment of a blending containment assembly is generally referred to by 200. Blending containment assembly 200 may be used in an assembly that dispenses and mixes beverages. Blending containment assembly 200 may be used in an assembly that dispenses and mixes beverages as described in U.S. patent application Ser. No. 12/633,790, filed Dec. 8, 2009, the contents of which are incorporated herein by reference in its entirety. This disclosure describes a method of sealing around a cup lip 402 of a cup 400 while contents of cup 400 are being blended in a blend-in-cup (BiC) beverage dispenser. The purpose of a BiC beverage dispenser is to dispense raw ingredients into a disposable cup and blend the beverage to its final consistency within the disposable cup. Cup 400, for example, is made of a Styrofoam material or plastic material.

Blending containment assembly 200 has a cup seal 209 and cover 308. Cup seal 209 is flexible. Cup seal 209 has an aperture 211 through a center wall 213. Cup seal 209 has a side wall 215 extending from the center wall 213. Side wall 215 has an engagement surface 217. Side wall 215 surrounds a space 219. Engagement surface 217 is tapered inward to form an angled surface. The geometry of engagement surface 217 which, when engaged to the cup lip, creates a seal between inside 403 and outside 405 of cup 400. The size and angle of engagement surface 217 is such that a multitude of diameters of cup lip 402 may be used without changing cup seal 209. The size and angle of engagement surface 217 may center cup 400 relative to cup seal 209 as cover 308 is moved towards cup 400 into contact with cup lip 402. Engagement of cup seal 209 with cup 400 minimizes or prevents rotation of cup during a blend cycle when a blade 3 rotates in cup 400.

Cup seal 209 is shaped to fit in cover 308. Cover 308 has a cover wall 302. Cover wall 302 has a side portion 304 and a center portion 306. Center portion 306 has an aperture 312. Center portion 306 is connected to guide rods 310. Guide rods 310 have first ends 313 that are fixed to cup cover 308.

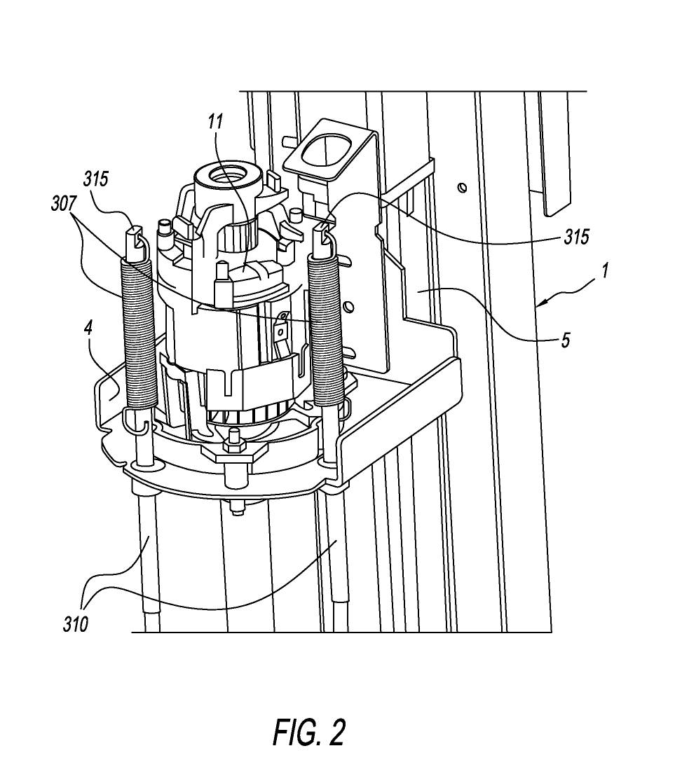

Referring to FIG. 2, guide rods 310 are connected to a blender bracket 4 of a blender assembly 1. Guide rods 310 have second ends 315 that are attached to blender bracket 4 via springs 307.

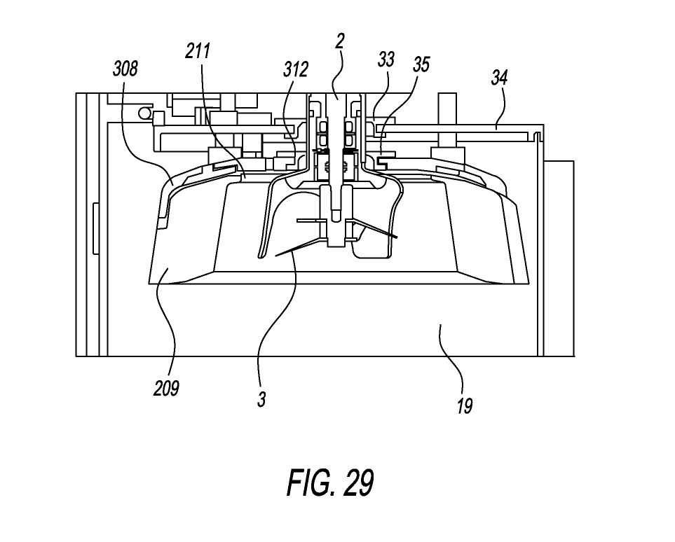

Referring back to FIG. 1, blender assembly 1 has a blender motor 11 with a shaft assembly having a spindle 2 which drives a blade 3. Spindle 2 is positioned through aperture 312 through cover 308 and aperture 211 through cup seal 209. Referring to FIG. 29, shaft 2 is sealed in two places. A chamber seal 33 is between shaft 2 and a top wall 34 of a blend chamber 19 and a cover seal 35 is between spindle 2 and cover 308. Chamber seal 33 and cover seal 35 may each be a simple rubber wiper seal, but there are a number of types of shaft seal that could alternatively be employed.

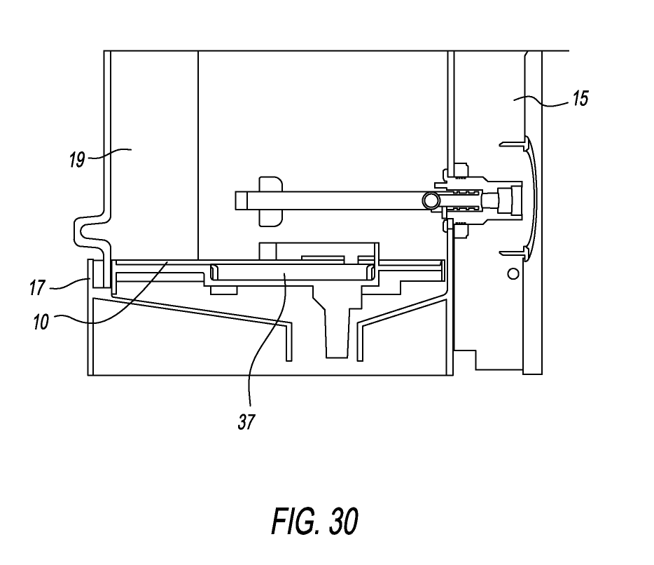

Referring back to FIG. 1, blade 3 is surrounded by a blade guard 20. Blender motor 11 is connected to blender bracket 4 which is fixed to a linear actuator 5 which allows vertical movement of blender assembly 1. Linear actuator 5 is connected to a support structure 15. Support structure 15 is connected to a base 17 of blend chamber 19 that contains a grate 10 to hold cup 400 in place during a blend cycle. Referring to FIG. 30, a centering ring 37 is attached to grate 10 in a bottom of blend chamber 19. Centering ring 37 and cup seal cup seal 209 work in tandem. Centering ring 37 is designed to close a gap between a largest cup's bottom diameter of a cup bottom 439 (see FIG. 1) of cup 400 and grate 10, and center cup bottom 439 with blade 3. Centering ring 37 has a shape, for example, a circle. A size of engagement surface 217 ensures that cup 400 with a smallest bottom diameter of cup bottom 439 still is sealed during a blend cycle despite there being a gap allowing cup 400 to move around within grate 10.

Referring back to FIG. 1, blend chamber 19 has nozzles 21 in a tube 23. Tube 23 has a connector 25 that receives water from a water source to form a water spray in blend chamber 19 to rinse blend chamber 19 and cup seal 209.

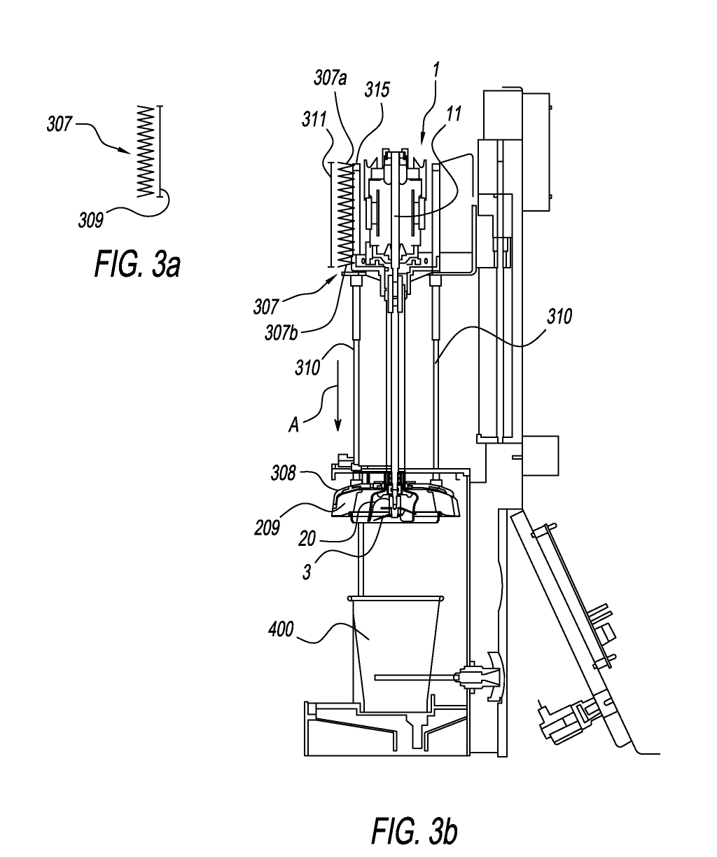

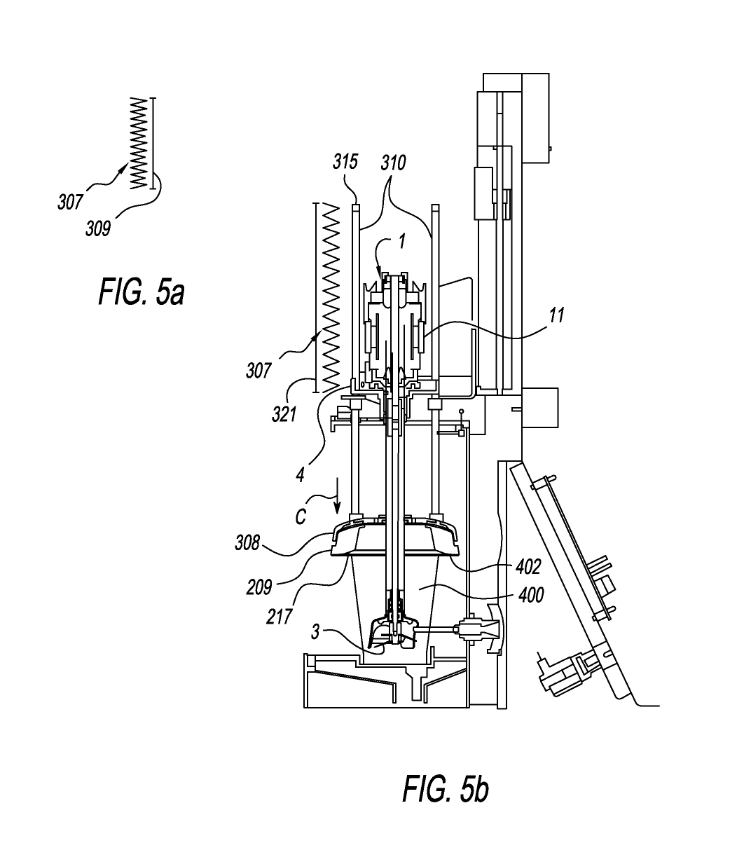

FIG. 3a shows spring 307 having a free length 309. FIG. 3b shows blender assembly 1 in a home position having blade 3 positioned above cup 400. Spring 307 is shown in FIG. 3b next to one of guide rods 310 to illustrate a home position length 311 as compared to free length 309. However, one spring 307 is around each of guide rods 310 in use. Spring 307 generates a force A in a direction as shown by arrow A on guide rods 310 that urges cover 308 onto blade guard 20. Home position length 311 of spring 307 in FIG. 3b is longer than free length 309 in FIG. 3a because spring 307 is stretched a small amount in order to apply a small amount of force from second end 315 of guide rod 310 where a first end 307a of spring 307 is attached to guide rod 310. Spring 307 has a second end 307b that is fixed to blender bracket 4. Once cup seal 209 contacts cup lip 402, as blender motor 11 continues to move downward moving blade 3 into cup 400, as shown in FIG. 5b, blender bracket 4 moves away from second ends 315 of guide rod 310 because guide rod 310 is stopped by cup lip 402. This relative displacement of blender bracket 4 stretches spring 307 and increases a force to cup lip 402.

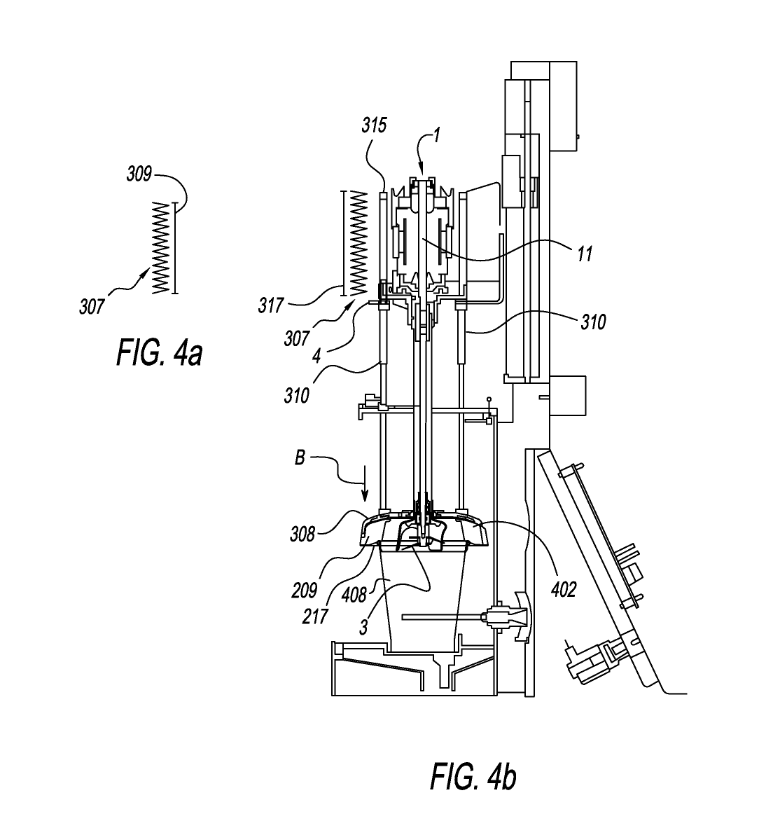

FIG. 4a shows spring 307 having free length 309. FIG. 4b shows blender assembly 1 in an engaged position having blade 3 positioned at the moment the cup seal 209 comes into contact with cup 400. Spring 307 is shown in FIG. 4b next to one of guide rods 310 to illustrate an engaged position length 317, which is the same as the home position length 311, as compared to free length 309. However, one spring 307 is around each of guide rods 310 in use. Spring 307 generates force B in a direction as shown by arrow B on cover 308 that urges engagement surface 217 of cup seal 209 onto a lip 402 of cup 400 in the engaged position. At this point, cover 308, blade guard 20, spindle 2 and blade 3 have been moving as one. FIG. 4b shows the instant that the force from cover 308 and cup seal 208 is transferred from blade guard 20 to cup lip 402. After this point shown in FIG. 4b, blade guard 20, spindle 2 and blade 3 will move independently of cover 308 and cup seal 208 to stretch spring 307 further.

FIG. 5a shows spring 307 having free length 309. FIG. 5b shows blender assembly 1 in a lowered position having blade 3 positioned inside of cup 400. Spring 307 is shown in FIG. 5b next to one of guide rods 310 to illustrate lowered position length 321 as compared to free length 309. However, one spring 307 is around each of guide rods 310 in use. Spring 307 generates force in a direction as shown by arrow C on cover 308 that urges engagement surface 217 of cup seal 209 onto a lip 402 of cup 400 in the engaged position. Force C is greater than Force B. A number of guide rods 310 that have springs 307 and a spring force of each of springs 307 can be varied to tune the amount of force that is applied to cup lip 402. Different materials of cup 400 and different cup lip designs of cup lip 402 may require different amounts of force to properly seal cup 400. The force on cup 400 by cup seal 209 should always be minimized to reduce wear and tear on the linear actuator.

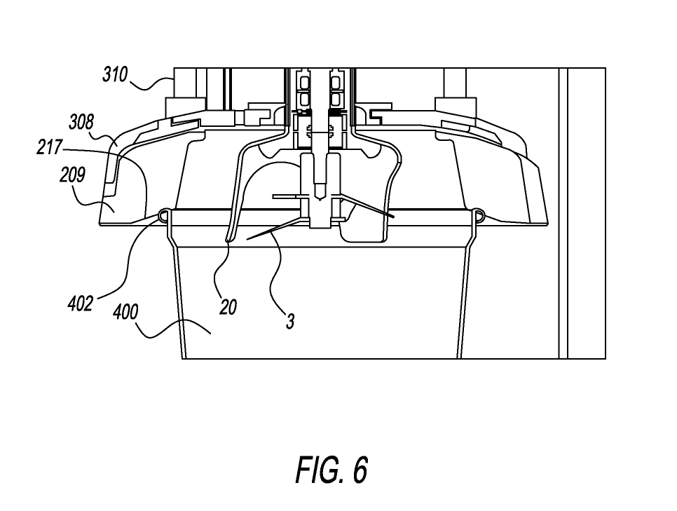

Referring to FIG. 6, in the engaged position and the lowered position, cup seal 209 is positioned in cover 308. A force applied by springs 307, for example, Force B, shown in FIG. 4b, or Force C, as shown in FIG. 5b, and a material of cup seal 209 allow cup seal 209 to conform to cup lip 402 creating a seal. Cup seal 209 is a material that is flexible, for example, low durometer food grade elastomer. The material selection of cup seal 209 is critical. For example, cup seal 209 can have a non-hydroscopic, non-porous food grade material cup seal 209 that needs to conform to cup lip 402 of cup 400, so hardness of cup seal 209 is minimized. It has been found by the present disclosure that durometers from 20 Shore A to 70 Shore A, preferably from 20 Shore A to 40 Shore A, and most preferably 30 Shore A, work well with the lower numbers being better for sealing but not as good for toughness against tearing and cutting. Cup seal 209 can preferably contact cup lips of cups having a diameter between 3.57 and 3.95 inches, and most preferably a diameter of 3.76 inches. The total range is dependent on the total tolerance stackup of the blender assembly. The range of diameters that can be sealed can be either tuned to a specific diameter or widened by creating a new seal with a different sealing surface.

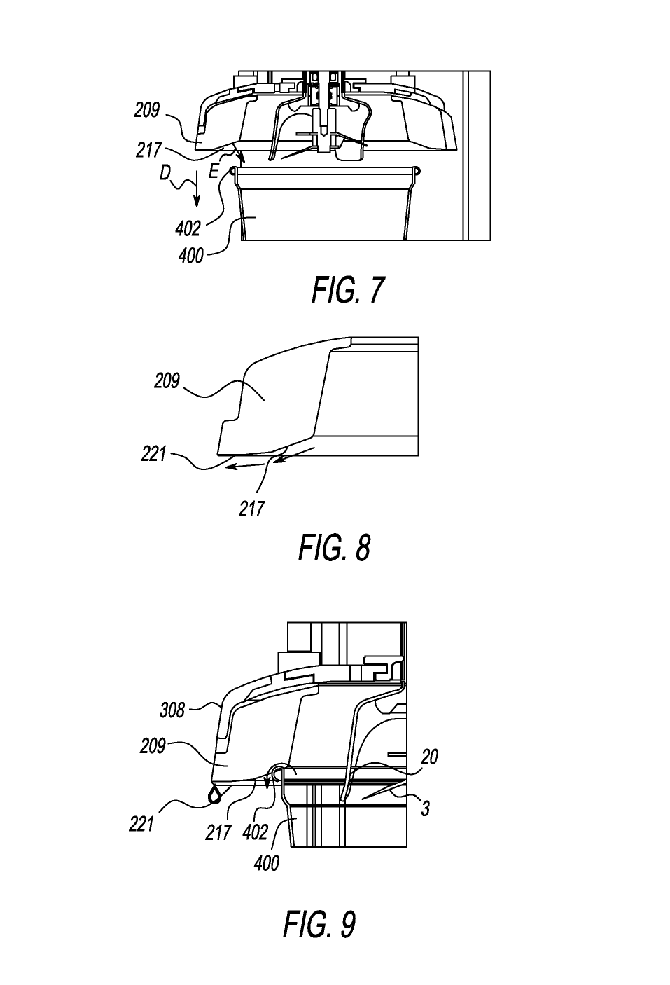

Referring to FIG. 7, as blender assembly 1 moves downward, cover 308 and cup seal 209 move in direction D, the angle of engagement surface 217 applies a force E in a direction as shown by arrow E on any objects on or near cup lip 402 to push the objects toward a center of cup 400. Engagement surface 217 is biased in such a way as to reduce the likelihood of foreign objects remaining on cup lip 402 of cup 400 to interfere with the seal formed between cup 400 and cup seal 209.

Referring to FIGS. 8 and 9, cup seal 209 has a bottom surface 221 adjacent engagement surface 217. Bottom surface 221 and engagement surface 217 are angled to allow rinse water to quickly run off bottom surface 221 and engagement surface 217. Any beading of water will occur far from an area where sealing occurs between engagement surface 217 and cup lip 402. Bottom surface 221 and engagement surface 217 are angled in such a way as to allow rinse water to quickly run away from engagement surface 217, where the water might redeposit the cup contents from inside 403 of cup 400 to outside 405 of cup 400 via capillary action.

In use, springs 307 are assembled in such a way as to provide a minimum initial force which holds cover 308 against blade guard 20 as shown in FIG. 3b. Once the blend cycle is initiated linear actuator 5 moves blender assembly 1 down into position, with blade 3 and cover 308 moving in tandem. At a point of contact between cup seal 209 and cup 400 containing unblended beverage ingredients, blade 3 continues to move and cover 308 remains in position, stopped by cup lip 402. At this point, the minimum force exerted by cover 308 onto blade guard 20 is transferred to cup lip 402 as shown in FIG. 4b. As blade 3 is moved by linear actuator 5 down into cup 400, springs 307 extend and exert additional force through cup seal 209 to cover 308, as shown in FIG. 5b. Once the blend cycle is completed, linear actuator 5 retracts blade 3 and blade guard 20 contacts cover 308 so as to again provide the minimum initial force which holds cover 308 against blade guard 20 as shown in FIG. 3b.

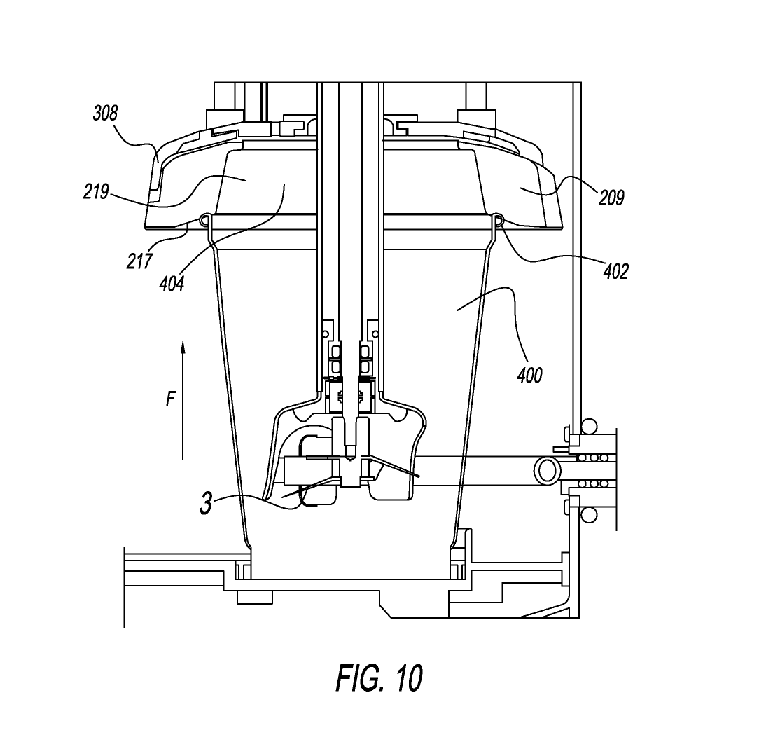

Referring to FIG. 10, during a blending cycle, blade 3 is rotated and ingredients in cup 400 begin to thicken. Ingredients in cup 400, for example, are ice and liquid that provides flavoring. Solids, for example, fruit or chocolate, may also be included in the ingredients in cup 400. When engagement surface 217 is in contact with cup lip 402 space 219 forms an overflow volume 404. During the blending cycle, if blade moves from a bottom of cup 400, as shown in FIG. 10, upwards as shown by arrow F, blade 3 will also move the beverage ingredients, in particular, blade 3 will move the beverage ingredients if they have been thickened. Overflow volume 404 allows the beverage ingredients to move above cup lip 402 into overflow volume 404 without spilling out of cup 400. Cup seal 209 creates overflow volume 404 above the cup lip 402 for the beverage ingredients to move into during the blend cycle.

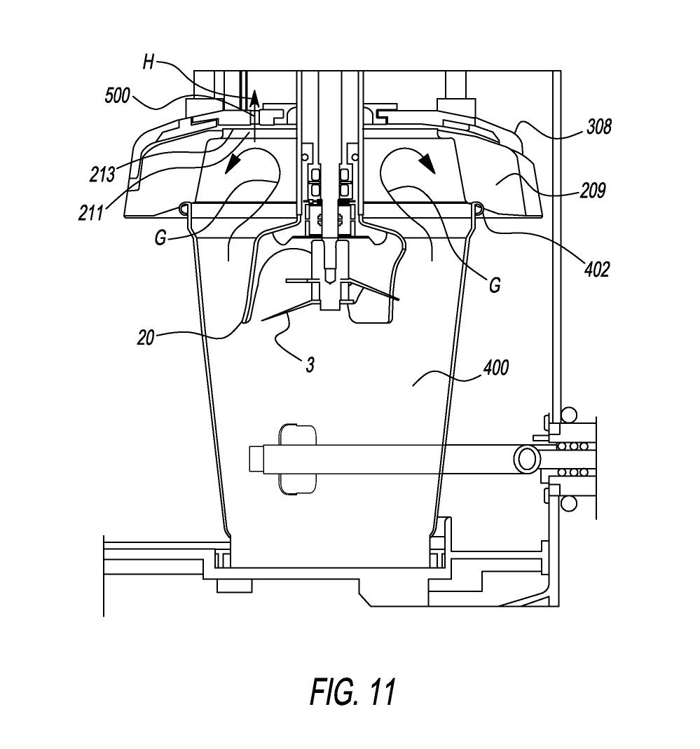

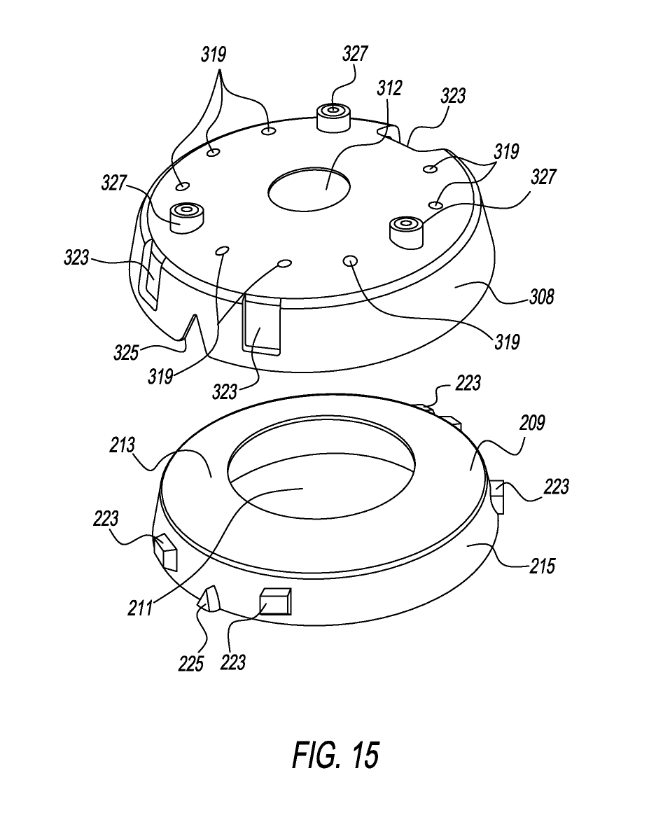

Referring to FIG. 11, if the beverage ingredients are sufficiently thickened, the beverage ingredients will rise in a single solid mass with blade 3 and can reduce a volume of air in overflow volume 404. Cover 308 forms a vent 500. A flow of air moves upward as shown by arrows G, and a flow of air as shown by arrow H can pass through vent 500. Cup seal 209 has aperture 211 with an inner diameter exposing a large area of cup cover 308. Vent 500 is an open hole through cup cover 308 and does not affect the cup seal 209. FIGS. 15 and 29 show the inner diameter of aperture 211 of cup seal 209 that is much smaller than cup cover 308. Vent 500 ensures the movement of air when there is a reduction of the volume of air in overflow volume 404 will not create a rise in pressure that could compromise the seal formed between engagement surface 217 of cup seal 209 and cup lip 402. Overflow volume 404 is vented by vent 500 so that the overflowing beverage ingredients will not create a pressurized bubble that could compromise the seal between cup seal 209 and cup 400.

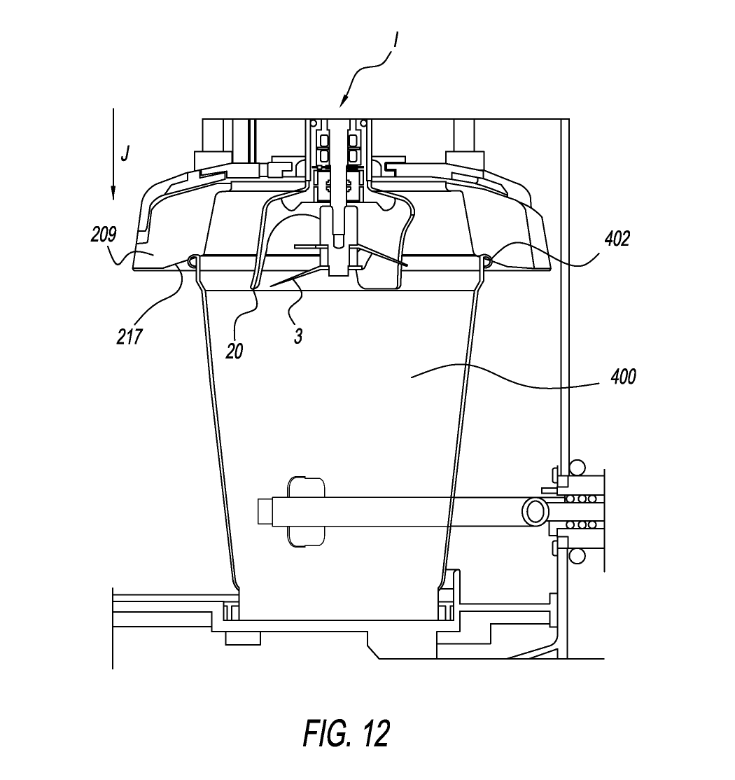

Referring to FIG. 12, as blender assembly 1 moves downward as shown by arrow J into the engaged position at a beginning of the blend cycle, engagement surface 217 of cup seal 209 forms the seal with cup lip 402 prior to blade 3 and blade guard 20 getting very far into cup 400. A portion of blade 3 and blade guard 20 are submerged in cup 400 prior to engagement surface 217 of cup seal 209 forming the seal with cup lip 402. Engagement surface 217 is positioned at the same approximate height as blade 3 to eliminate the possibility of blade 3 displacing the beverage ingredients over cup lip 402 of cup 400 before cup seal 209 is engaged with cup 400.

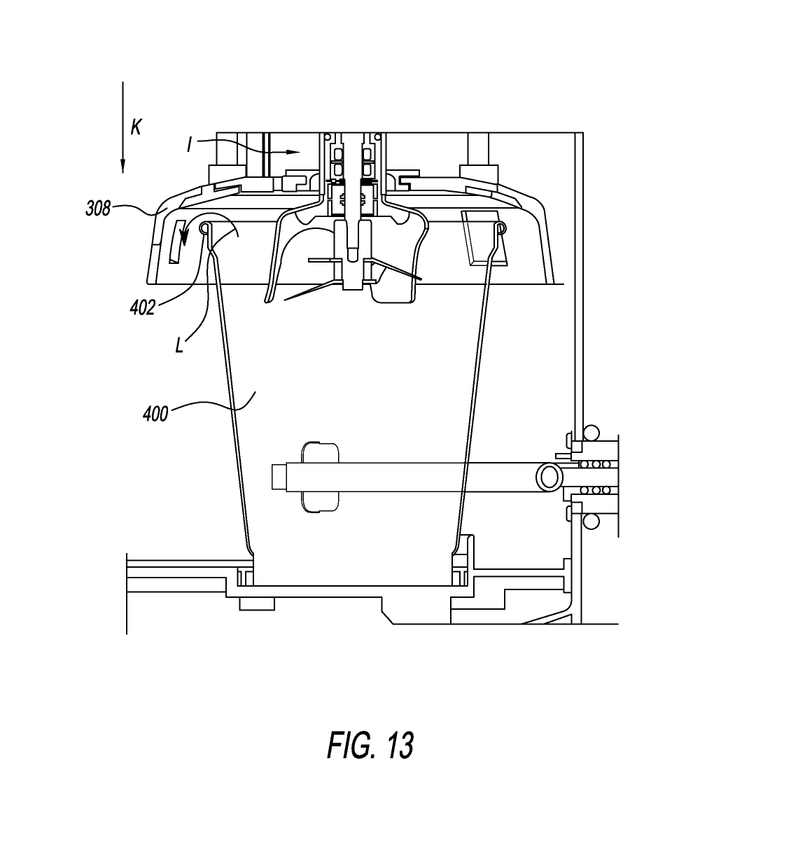

Referring to FIG. 13, cover 308 is shown without cup seal 209. As blender assembly 1 moves downward as shown by arrow K into the engaged position at a beginning of the blend cycle into cup 400, blade 3 and blade guard 20 will displace the beverage ingredients that are un-blended upward. If cup 400 is sufficiently full with the beverage ingredients, the beverage ingredients that are un-blended will rise above cup lip 402 as shown by arrow L. Accordingly, engagement surface 217 of cup seal 209 that forms the seal with cup lip 402 prior to blade 3 and blade guard 20 getting very far into cup 400 prevents the beverage ingredients that are un-blended that rise above cup lip 402 from spilling out of cup 400. It is important for cup 400 to be full of the beverage ingredients that are un-blended so that the blended beverage adequately fills cup 400 such that the customer gets the proper portion of the beverage.

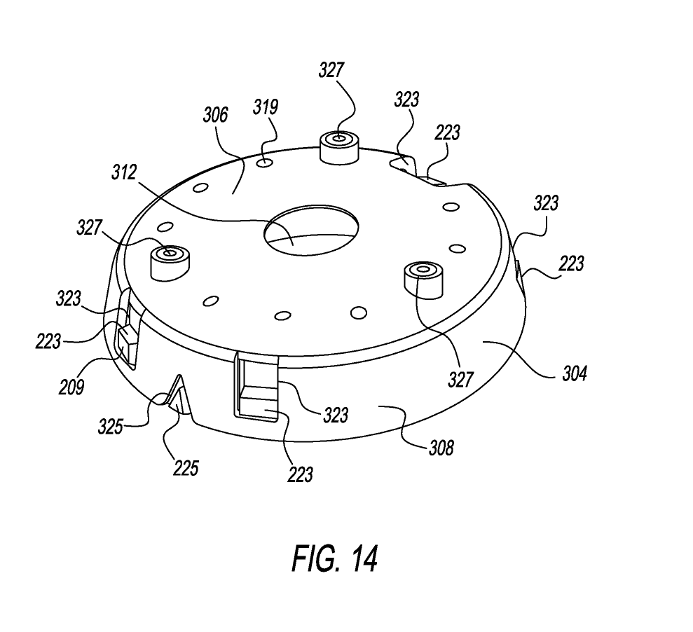

Referring to FIGS. 14 and 15, cover 308 has connection apertures 323 and groove 325. Cover 308 also has receiving holes 327. Each of receiving holes 327 connects to one of guide rods 310.

Cup seal 209 has protrusions 223 and a protuberance 225. Cup seal 209 fits in cover 308 so that protrusions 223 pass through connection apertures 323 to maintain a connection between cup seal 209 and cover 308. Protuberance 325 fits through groove 325. Protuberance 325 and groove 325 orient cup seal 209 in cover 308. Protrusions 223 and connection apertures 323 create a connection between cup seal 209 and cover 308 that is removable. Cup seal 209 is removable from cover 308 for quick cleaning or replacement.

### EXAMPLE

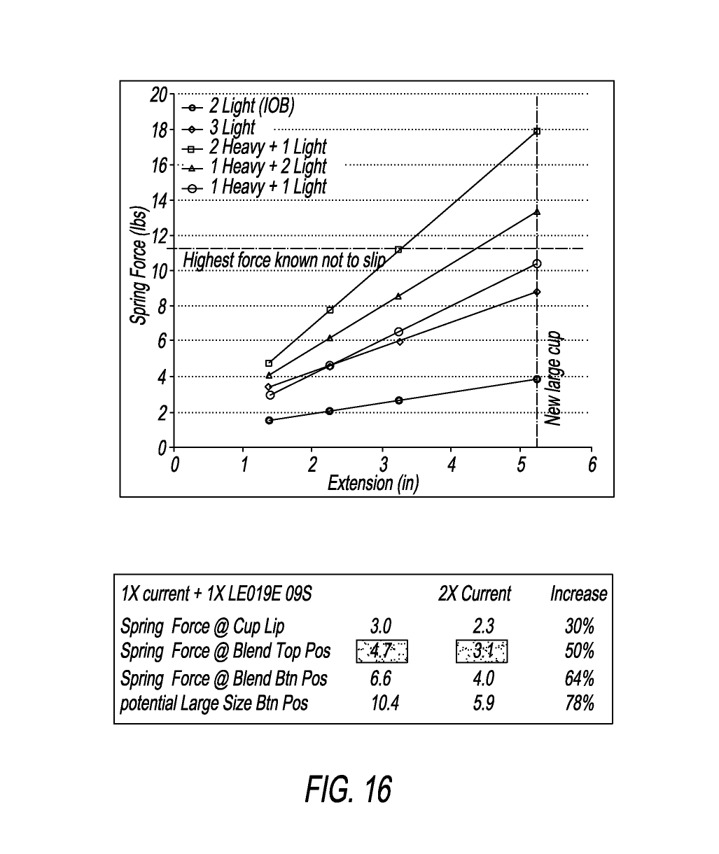

Referring to FIG. 16, a cup seal was constructed of a 30 Shore A durometer liquid silicone compression molded into shape. Springs were tuned to provide 4.7 pounds of force from the cup seal onto the cup lip in the blender's to blending position, which is the maximum force we could achieve in this position without exceeding the observed minimum force output of the linear actuator of 11 pounds. FIG. 16 shows spring forces for various combinations of springs at key points in the blend cycle, the upper line with circles is associated with the data table below the chart and is used in this example. This spring combination keeps the force required by the linear actuator to below 11 pounds while still creating nearly 5 pounds of sealing force at the highest point in the blend cycle.

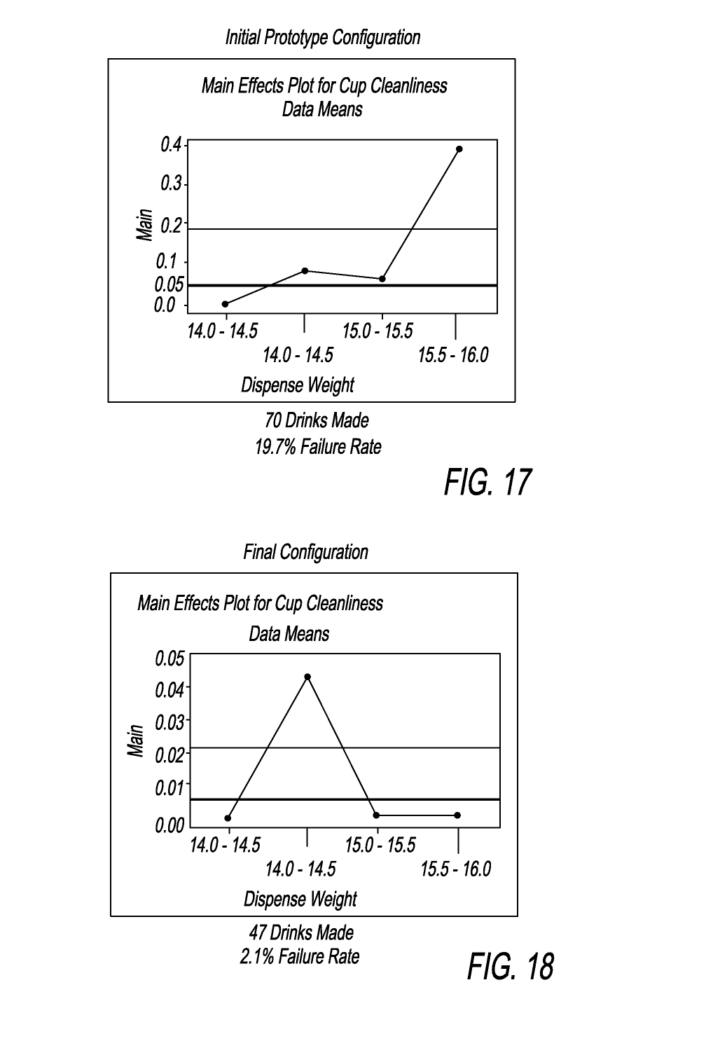

Referring to FIGS. 17-18, blending containment assembly 200 in accordance with the present disclosure resulted in 2.1 percent of cups leaking past the seal in lab testing compared with nearly 100 percent leaks without a dedicated seal and 19.7 percent leaks from a cover without a cup seal.

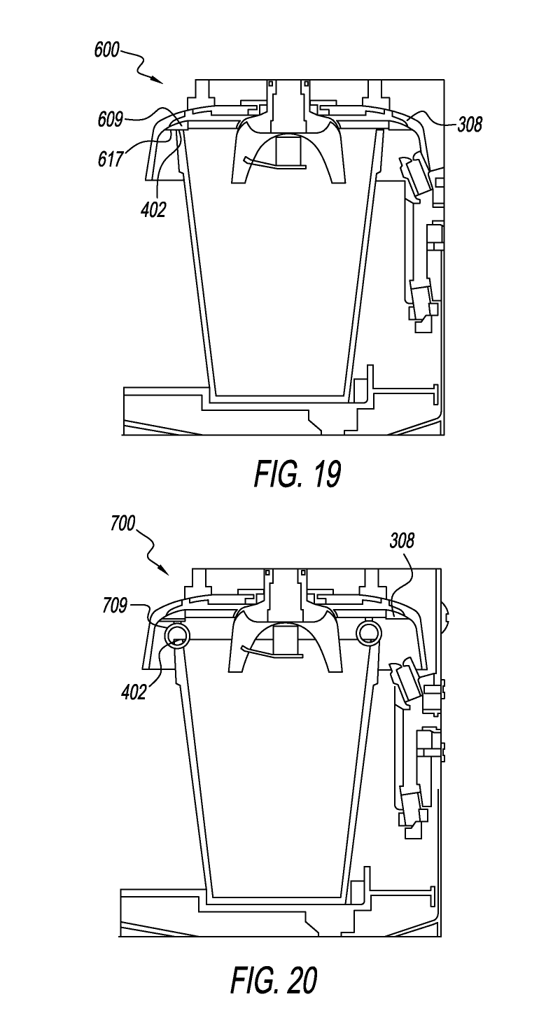

FIG. 19 illustrates another embodiment of a blending containment assembly that is generally referred to by 600. Blending containment assembly 600 is similar to blending containment assembly 200, but has a different cup seal 609 than cup seal 209. Cup seal 609 is a flexible material that has a flat engagement surface 617. Flat engagement surface 617 contacts a top portion of cup lip 402 to form a seal.

FIG. 20 illustrates another embodiment of a blending containment assembly that is generally referred to by 700. Blending containment assembly 700 is similar to blending containment assembly 200, but has a different cup seal 709 than cup seal 209. Cup seal 709 is a flexible material that has a tubular shape to contact cup lip 402 to form a seal.

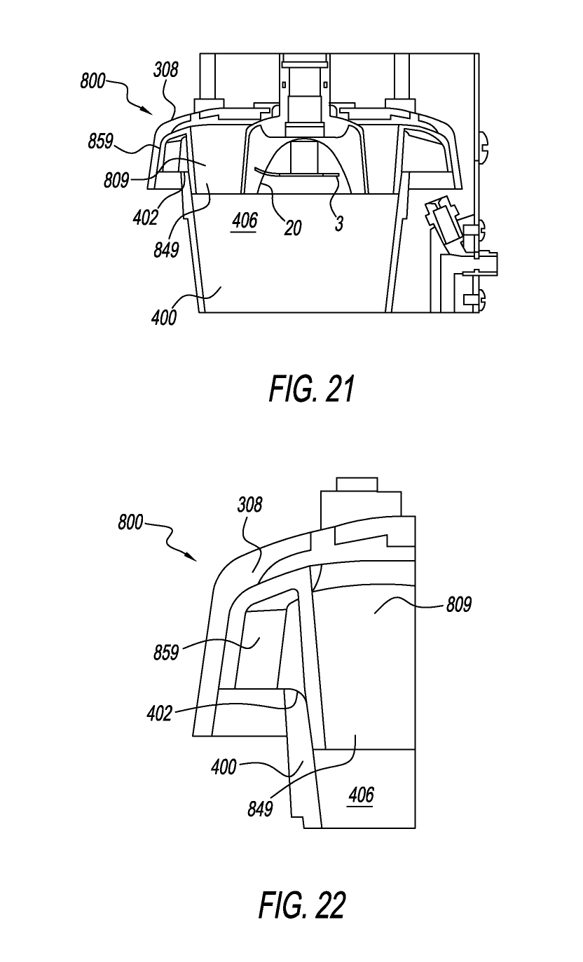

FIGS. 21-22 illustrate another embodiment of a blending containment assembly that is generally referred to by 800. Blending containment assembly 800 is similar to blending containment assembly 200, but has a different cup seal 809 than cup seal 209. Cup seal 809 is a flexible material that has an inner side wall 849 and an outer side wall 859. In use, inner side wall 849 is positioned inside cup 400 to form a seal with an inner surface 406 of cup 400. Outer side wall 859 is sized to fit in cover 308.

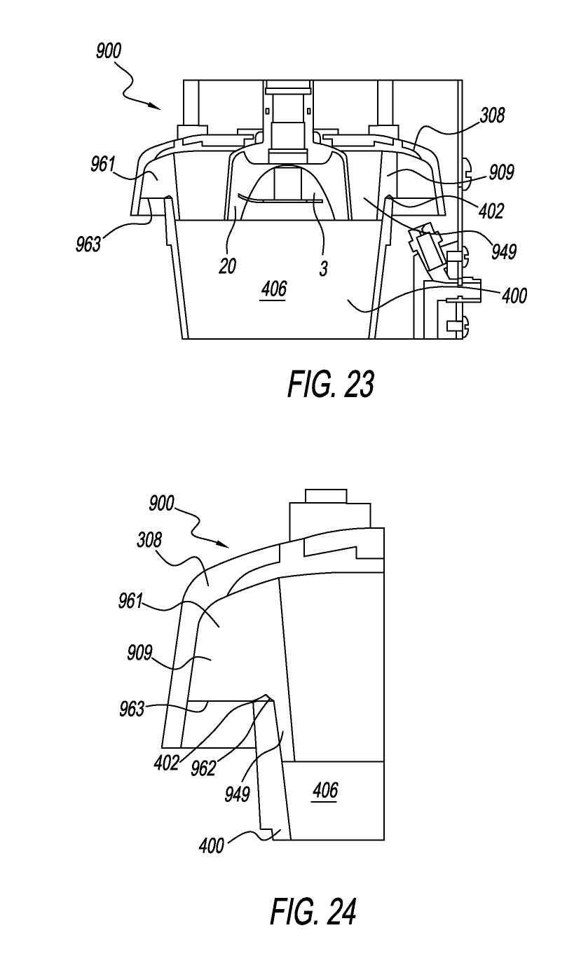

FIGS. 23-24 illustrate another embodiment of a blending containment assembly that is generally referred to by 900. Blending containment assembly 900 is similar to blending containment assembly 200, but has a different cup seal 909 than cup seal 209. Cup seal 909 is a flexible material that has an inner wall 949 extending from an outer wall 961. Outer wall 961 has a bead 962 extending from a bottom surface 963. In use, inner wall 949 is positioned inside cup 400 to contact inner surface 406 and bead 962 and bottom surface 963 of outer wall 961 contact cup lip 402 to form a seal between cup seal 909 and cup 400. Outer wall 961 is sized to fit in cover 308.

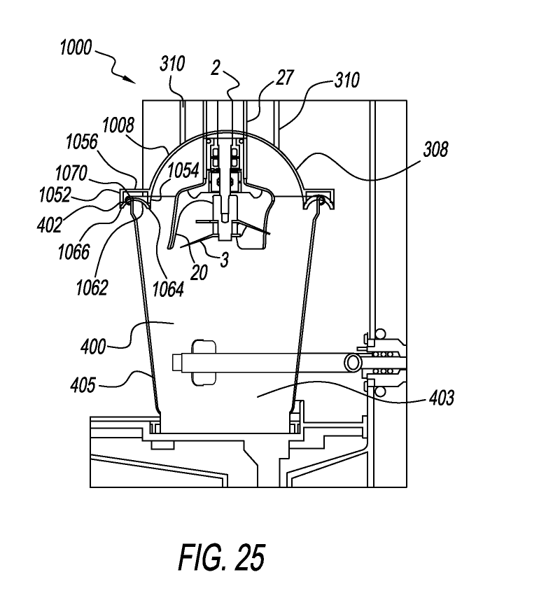

FIG. 25 illustrates another embodiment of a blending containment assembly that is generally referred to by 1000. Blending containment assembly 1000 is similar to blending containment assembly 200, but instead of cup seal 209, blending containment assembly 1000 has rods 310 connected to cover 308 that is a housing 1008 that connects to a membrane 1062. Housing 1008 has an outer connector wall 1052 and an inner connector wall 1054 connected to opposite sides of a middle connector wall 1056. Membrane 1062 has an inner edge 1064 and an outer edge 1066. Inner edge 1064 is connected to inner connector wall 1054 and outer edge 1066 is connected to outer connector wall 1052. Outer connector wall 1052, inner connector wall 1054, middle connector wall 1056 and membrane 1062 form a space 1070. Membrane 1062 is a flexible sheet of material. A seal could be achieved with membrane 1062 that is a very thin stretchable silicone having a thickness between 1/16 inch and 1/32 inch. Membrane 1062 as opposed to a thick gasket may allow the reduction in spring force of springs 307 required because membrane 1062 is more flexible, and will be better able to conform to cup lip 402 to create a larger sealing surface requiring much less compression force.

In use, blending containment assembly 1000 is moved downward with blender assembly 1 moving membrane 1062 into contact with cup lip 402. Membrane 1062 expands into space 1070 conforming into the shape of cup lip 402 forming a seal between inside 403 and outside 405 of cup 400. When housing 1008 is moved upward with blender assembly 1, membrane 1062 contracts to a relaxed shape.

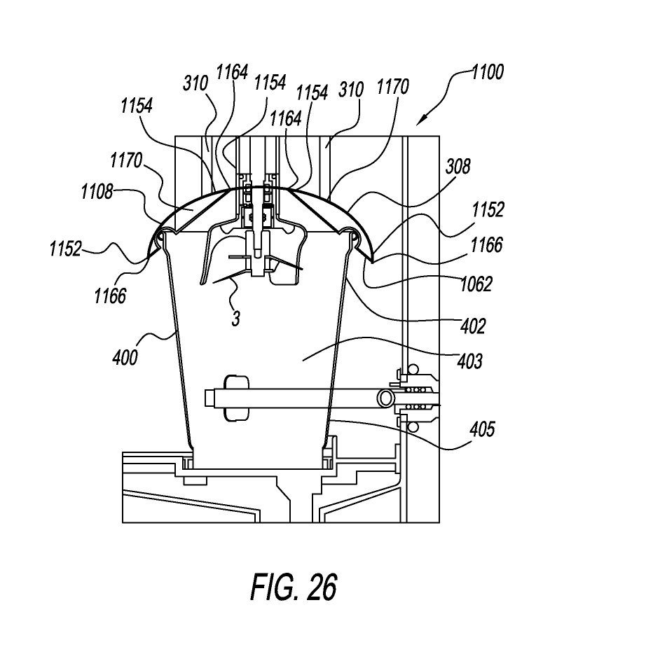

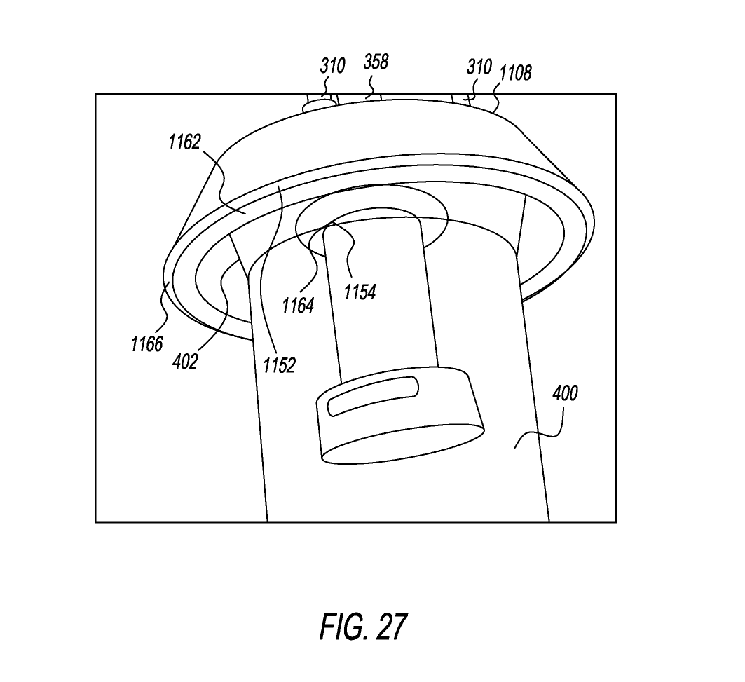

FIGS. 26-27 illustrates another embodiment of a blending containment assembly that is generally referred to by 1100. Blending containment assembly 1100 is similar to blending containment assembly 200, but instead of cup seal 209, blending containment assembly 1100 has rods 310 connected to cover 308 that is a housing 1108 that connects to a membrane 1162. Housing 1108 has an outer connector edge 1152 and an inner connector edge 1154. Membrane 1162 has an inner edge 1164 and an outer edge 1166. Inner edge 1164 is connected to inner connector edge 1154 and outer edge 1066 is connected to outer connector edge 1052. Housing 1108, outer connector edge 1054, inner connector edge 1154 and membrane 1062 form a space 1170. Membrane 1162 is a flexible sheet of material. A seal could be achieved with membrane 1162 that is a very thin stretchable silicone having a thickness between 1/16 inch and 1/32 inch.

In use, blending containment assembly 1100 is moved downward with blender assembly 1 moving membrane 1162 into contact with cup lip 402. Membrane 1162 expands into space 1170 conforming into the shape of cup lip 402 forming a seal between inside 403 and outside 405 of cup 400. When housing 1108 is moved upward with blender assembly 1, membrane 1162 contracts to a relaxed shape.

Membrane 1162 forms an angle to apply a force on any objects on or near cup lip 402 to push the objects toward a center of cup 400, and the angle allows rinse water to quickly run off membrane 1162. Any beading of water will occur far from an area where sealing occurs between membrane 1162 and cup lip 402.

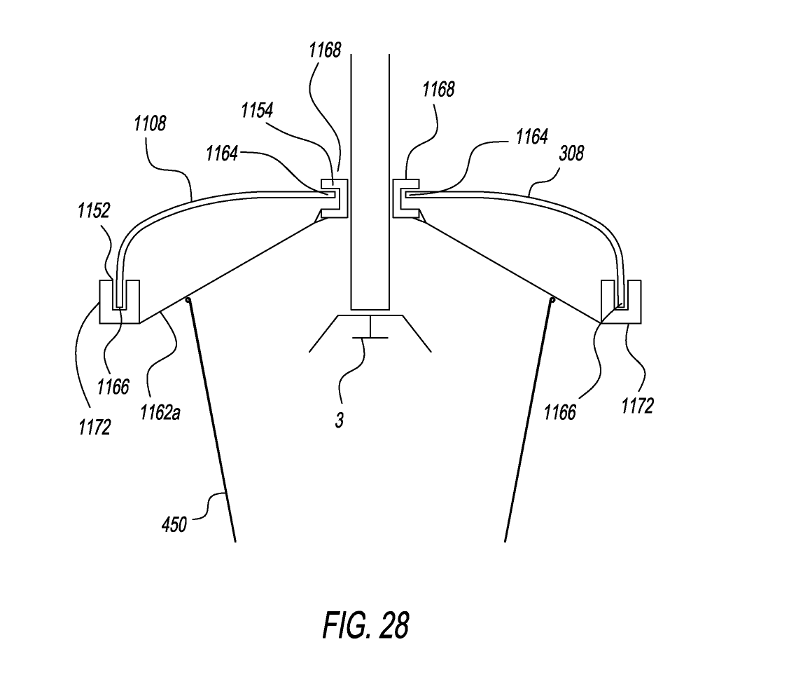

Referring to FIG. 28, membrane 1162a is the same as membrane 1162 except membrane 1162a has inner edge 1164 connected to an inner connector 1168 and outer edge 1166 is connected to an outer connector 1172. Inner connector 1168 and outer connector 1172 are rigid. Inner connector 1168 and outer connector 1172 are removable from housing 1108 to remove membrane 1168 from housing 1108.

Blending containment assembly 200 minimizes the drink preparation time of a BiC machine by eliminating the need for all non-automatic cleaning steps from the drink making process. This is achieved by keeping all of the contents of cup 400 within cup 400 during the blending cycle. The advantages of having a cup seal during blending are numerous. Customer satisfaction is provided by eliminating a situation where an un-sealed cup allows the contents of the cup, namely, the beverage ingredients, to spill over cup lip 402 during the blend cycle, causing cup 400 to be messy or sticky. Additionally blending containment assembly 200 allows cup 400 to be very full before the blend cycle begins to ensure the customer gets a full finished beverage. Sanitation is improved by eliminating a situation where cups need to be wiped clean before handing them to the customer, the potential is there for re-usable towels to be used. Towels can collect bacteria over time and deposit it back onto the cups given to customers. Speed of customer service is improved by keeping the outside of the cup clean throughout the beverage making process to minimize drink preparation time. Any BiC system without a cup seal, or other system which relies on the operator to manually pour the completed beverage into a cup, runs the risk of spillage onto the outside of the cup. This necessitates wiping the outside of the cup which increases the overall drink preparation time. Easy cleaning is provided by holding cup seal 209 in place via protrusions 223 and protuberance 225 which fit into mating openings in cover 308. The size of protrusions 223 and the low durometer of cup seal 209 make cup seal 209 easy to remove and replace cup seal 209 in cover 308 for daily cleaning and sanitation. Simple replacement is provided by cup seal 209 being an independent component of the blend system which can easily and quickly be replaced if damaged.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

What is claimed is:

1. A blending containment assembly comprising:
a cover having a first aperture; and
a cup seal connected to the cover, the cup seal being a flexible material having a second aperture, the cover and the cup seal configured to receive a spindle of a blending assembly in said first aperture and said second aperture, and the cover and the cup seal movable to engage a cup to create a seal between an inside of the cup and an outside of the cup.

2. The blending containment assembly of claim 1, wherein the cup seal has an engagement surface to contact the cup that is angled so that the engagement surface tapers inward.

3. The blending containment assembly of claim 1, wherein the cover forms a vent therein.

4. The blending containment assembly of claim 1, wherein the cup seal has a side wall extending from a center wall that create an overflow volume when engaged with the cup, and wherein the overflow volume is above the cup.

5. The blending containment assembly of claim 4, wherein the cover forms a vent through the cover from the overflow volume to outside of the cup, the cup seal and the cover.

6. The blending containment assembly of claim 1, wherein the cup seal is removable from the cover.

7. The blending containment assembly of claim 1, wherein the cup seal is elastomer.

8. The blending containment assembly of claim 1, further comprising a blender motor with spindle which drives a blade, wherein the blender motor is attached to a blender bracket which is connected to a linear actuator which allows vertical movement of the blender bracket and the blender motor with the spindle and the blade, further comprising at least one guide rod having a first end attached to the blender bracket via a spring, and wherein the guide rod has a second end opposite the first end that is fixed to the cover.

9. The blending containment assembly of claim 8, wherein the spring generates a force to hold the cover against a blade guard surrounding the blade in an initial position.

10. The blending containment assembly of claim 8, wherein the cover moves with the blender bracket prior to engagement of the cup seal with the cup.

11. The blending containment assembly of claim 8, wherein the spring applies a force to the cup that increases as the spindle and the blade extend into the cup.

12. The blending containment assembly of claim 8, wherein the cup seal has an engagement surface to contact the cup, and wherein the engagement surface that engages the cup prior to the blade displacing ingredients in the cup.

13. The blending containment assembly of claim 1, wherein the cup seal is 30 Shore A liquid silicone compression molded into shape.

14. The blending containment assembly of claim 1, wherein the cup seal has tubular shape.

15. The blending containment assembly of claim 1, wherein the cup seal has an engagement surface that contacts an inner surface of the cup.

16. The blending containment assembly of claim 1, wherein the cup seal is a flexible membrane that deforms to conform to a shape of the cup.
